(19) United States
(12) Patent Application Publication
(10) Pub. No.: US 2013/0253924 A1
(43) Pub. Date: Sep. 26, 2013

(54) Speech Conversation Support Apparatus, Method, and Program

(71) Applicants: Yumi Ichimura, Abiko-shi (JP); Kazuo Sumita, Yokohama-shi (JP)

(72) Inventors: Yumi Ichimura, Abiko-shi (JP); Kazuo Sumita, Yokohama-shi (JP); Masaru Sakai, Fuchu-shi (JP)

(73) Assignee: KABUSHIKI KAISHA TOSHIBA, Tokyo (JP)

(21) Appl. No.: 13/728,533

(22) Filed: Dec. 27, 2012

(30) Foreign Application Priority Data
Mar. 23, 2012 (JP) 2012-068328

(51) Int. Cl. G10L 15/22

(52) U.S. Cl. CPC G10L 15/22
USPC 704/233

(57) ABSTRACT

According to one embodiment, a speech conversation support apparatus includes a division unit, an analysis unit, a detection unit, an estimation unit and an output unit. The division unit divides a speech data item including a word item and a sound item into a plurality of divided speech data items. The analysis unit obtains an analysis result. The detection unit detects, for each divided speech data item, at least one clue expression indicating one of an instruction by a user and a state of the user. The estimation unit estimates, if the clue expression is detected, playback data item from at least one divided speech data item corresponding to a speech uttered before the clue expression is detected. The output unit outputs the playback data item.

### CROSS-REFERENCE TO RELATED APPLICATIONS

This application is based upon and claims the benefit of priority from Japanese Patent Application No. 2012-068328, filed Mar. 23, 2012, the entire contents of which are incorporated herein by reference.

### FIELD

Embodiments described herein relate generally to a speech conversation support apparatus, method, and program.

### BACKGROUND

Since speeches normally disappear immediately after being uttered, people can remember speech information only within the range of human memory capacity. Therefore, if an information amount to be memorized is large or the memory capacity decreases because of the decrease in ability to concentrate, people often miss an utterance. Accordingly, there is an apparatus that records speeches in conversation (conversation speeches), and efficiently plays back the conversation if there is information which the user has missed and wants to hear again.

### BRIEF DESCRIPTION OF THE DRAWINGS

FIG. 1 is a block diagram illustrating a speech conversation support apparatus according to the first embodiment;

FIG. 2 is a flowchart illustrating the operation of a division unit;

FIG. 3 is a flowchart illustrating another example of the operation of the division unit;

FIG. 4 is a view illustrating an example of a clue list table;

FIG. 5 is a flowchart illustrating the operation of a playback indication unit;

FIG. 6 is a flowchart illustrating the operation of a playback termination indication unit;

FIGS. 7A and 7B are flowcharts illustrating the operation of a playback portion estimation unit;

FIG. 8 is a flowchart illustrating the operation of a playback speed setting unit;

FIG. 9 is a flowchart illustrating another example of the operation of the playback speed setting unit;

FIGS. 10A and 10B are views illustrating examples of speech conversation to be input to a speech acquisition unit;

FIGS. 11A and 11B are views illustrating examples of speech data analyzed by a speech data analysis unit;

FIG. 12 is a block diagram illustrating a speech conversation support apparatus according to the second embodiment;

FIG. 13 is a flowchart illustrating the operation of a partial data extraction unit; and

FIG. 14 is a block diagram illustrating an example of a computer when implementing the speech conversation support apparatus as a program.

### DETAILED DESCRIPTION

For example, a technique that plays back utterances including keywords in recording order allows a person to recognize the content of conversation more efficiently than when playing back all conversation speeches, but keywords must be preset. That is, this technique is effective when objects and scenes are limited such as in conversation between sales staff and customers. However, keywords are difficult to set because topics of general conversation cover a wide range and cannot be predicted. There is another technique that plays back speeches by controlling the speech playback range, but the content of conversation cannot be taken into consideration.

In general, according to one embodiment, a speech conversation support apparatus includes a division unit, an analysis unit, a first detection unit, an estimation unit and an output unit. The division unit divides a speech data item including a word item and a sound item, into a plurality of divided speech data items, in accordance with at least one of a first characteristic of the word item and a second characteristic of the sound item. The analysis unit obtains an analysis result on the at least one of the first characteristic and the second characteristic, for each divided speech data item. The first detection unit detects, for each divided speech data item, at least one clue expression indicating one of an instruction by a user and a state of the user in accordance with at least one of an utterance by the user and an action by the user. The estimation unit estimates, if the clue expression is detected, at least one playback data item from at least one divided speech data item corresponding to a speech uttered before the clue expression is detected, based on the analysis result. The output unit outputs the playback data item.

A speech conversation support apparatus, method, and program according to an embodiment will be explained in detail below with reference to the accompanying drawings. Note that in the following embodiment, portions denoted by the same reference numbers perform the same operations, and a repetitive explanation will properly be omitted.

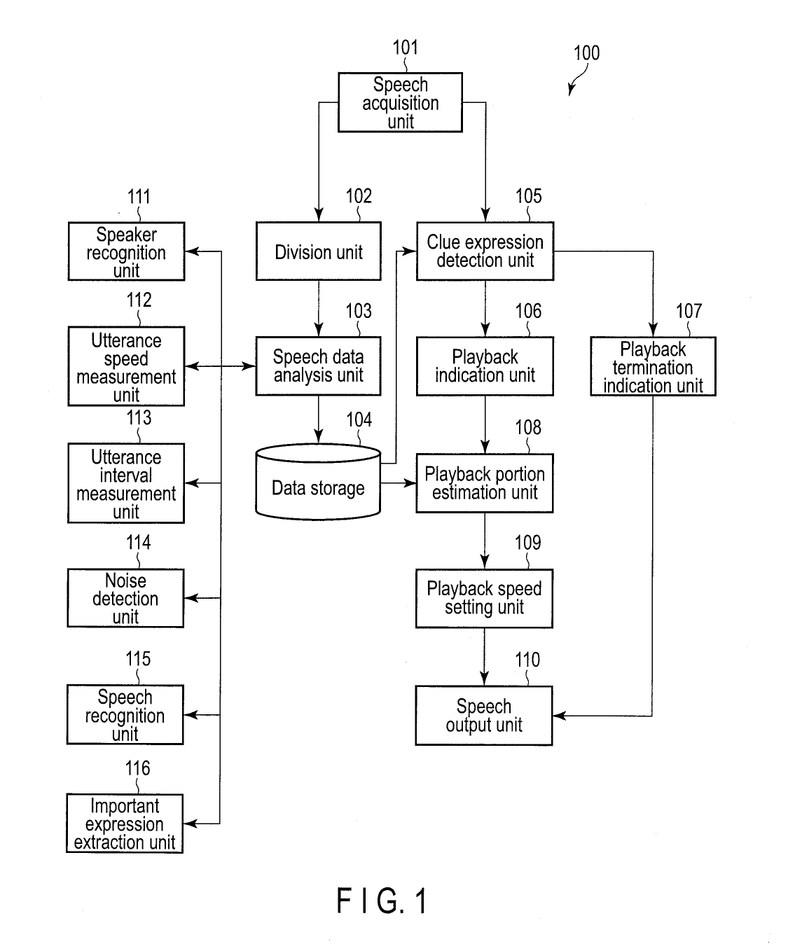

A use example of the speech conversation support apparatus according to this embodiment will be explained below with reference to FIG. 1.

A speech conversation support apparatus 100 according to this embodiment includes a speech acquisition unit 101, division unit 102, speech data analysis unit 103, data storage 104, clue expression detection unit 105, playback indication unit 106, playback termination indication unit 107, playback portion estimation unit 108, playback speed setting unit 109, speech output unit 110, speaker recognition unit 111, utterance speed measurement unit 112, utterance interval measurement unit 113, noise detection unit 114, speech recognition unit 115, and important expression extraction unit 116.

The speech acquisition unit 101 is, for example, a microphone, and acquires speeches generated from external sound sources as speech data including words and sound. The external sound sources are, for example, persons and loudspeakers. The sound according to this embodiment includes external environmental noise in addition to speeches.

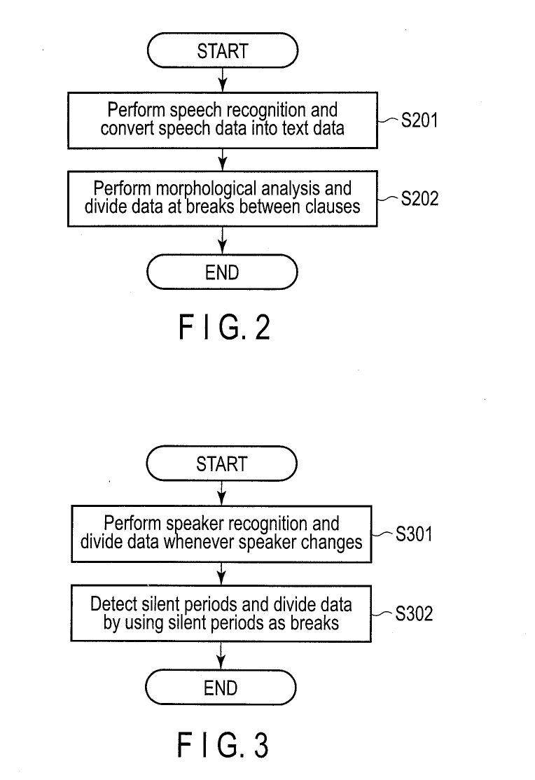

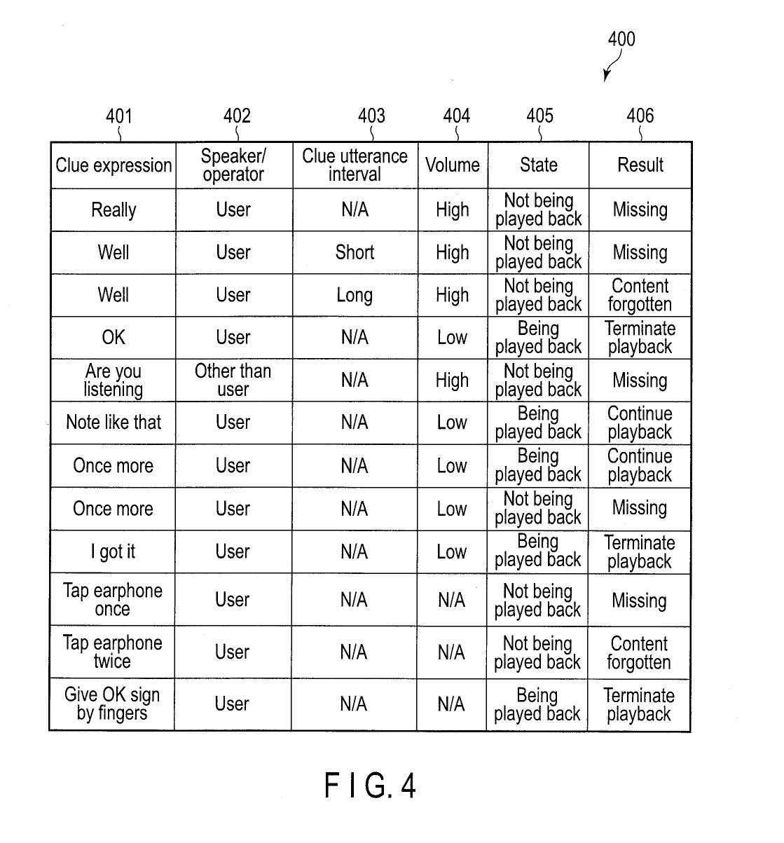

The division unit 102 receives the speech data from the speech acquisition unit 101, and divides the speech data in accordance with at least one of a word characteristic and sound characteristic, thereby obtaining a plurality of divided speech data. The dividing process by the division unit 102 will be described later with reference to FIGS. 2 and 3. The speech data analysis unit 103 receives the divided speech data from the division unit 102. The speech data analysis unit 103 obtains the result of analysis on at least one of the word characteristic and sound characteristic included in the divided speech data, by controlling the speaker recognition unit 111, utterance speed measurement unit 112, utterance interval measurement unit 113, noise detection unit 114, speech recognition unit 115, and important expression extraction unit 116 (each unit will be described later).

The data storage 104 receives the divided speech data and analysis result from the speech data analysis unit 103, and stores them as analytical data by associating them with each other.

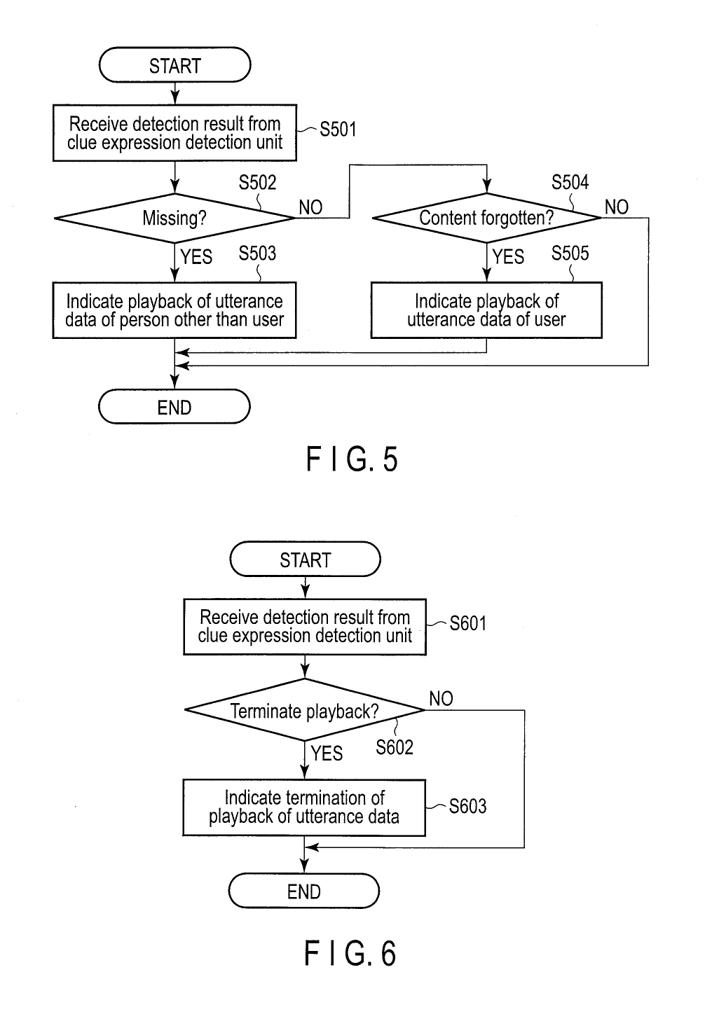

The clue expression detection unit 105 receives the speech data from the speech acquisition unit 101, and detects whether or not the speech data includes a word or action matching a clue expression by referring to a clue list. The clue expression indicates one of an instruction by the user and the state of the user by at least one of utterance by the user and the action of the user, and includes a clue word and clue action in this embodiment. The clue word indicates a word as a key to proceed to a predetermined process. The clue action indicates an action as a key to proceed to a predetermined process. Note that the clue expression detection unit 105 may also receive text data of the speech data from the data storage 104 (to be described later), and perform matching between the text data and clue expression. The clue list will be described later with reference to FIG. 4.

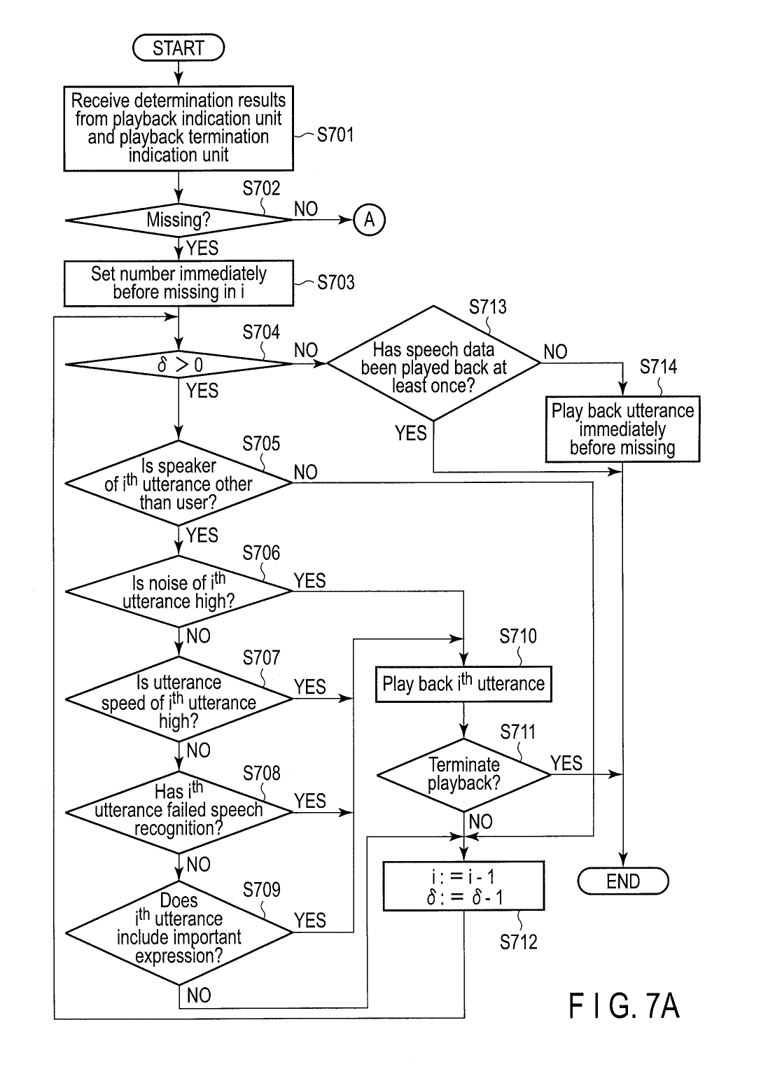

The playback indication unit 106 receives the clue expression processing result from the clue expression detection unit 105, and generates a playback indication signal for indicating playback of the speech data. The operation of the playback indication unit 106 will be described later with reference to FIG. 5.

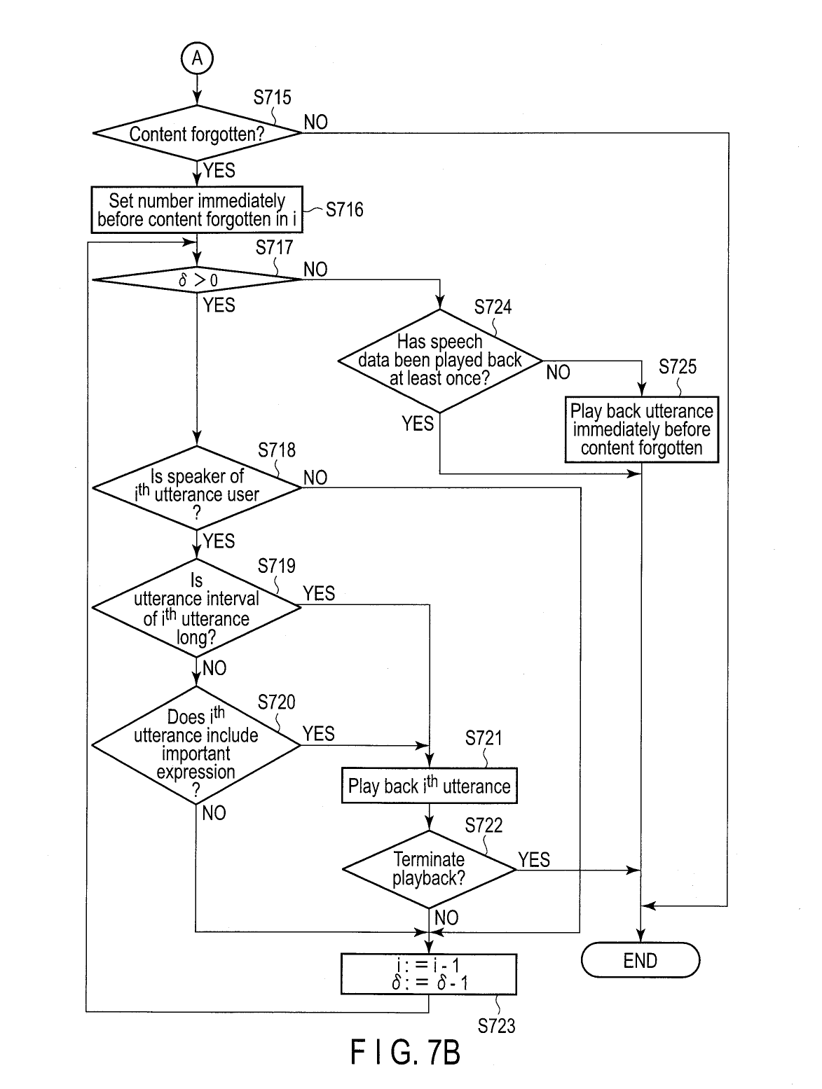

The playback termination indication unit 107 receives the clue expression processing result from the clue expression detection unit 105, and generates a playback termination indication signal for indicating playback termination of the speech data. The operation of the playback termination indication unit 107 will be described later with reference to FIG. 6.

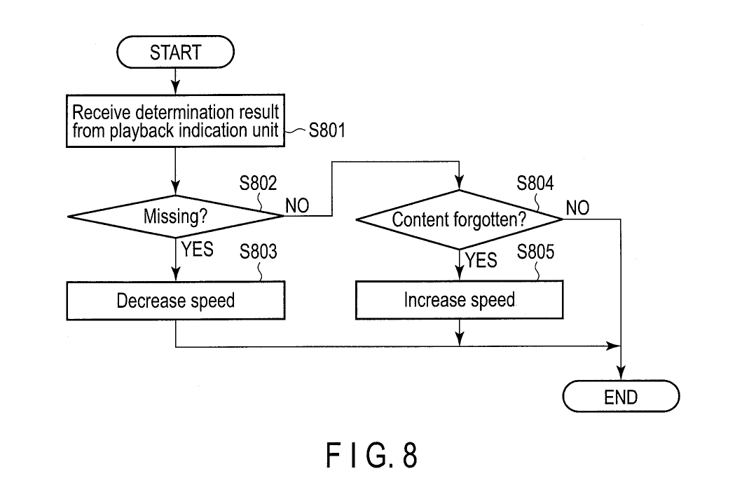

The playback portion indication unit 108 receives the playback indication signal from the playback indication unit 106, the playback termination indication signal from the playback termination indication unit 107, and the analytical data from the data storage 104. From divided speech data corresponding to speeches uttered before the clue expression is detected based on the analytical data, the playback portion estimation unit 108 sequentially extracts divided speech data to be played back, as playback data. The operation of the playback portion estimation unit 108 will be described later with reference to FIGS. 7A and 7B.

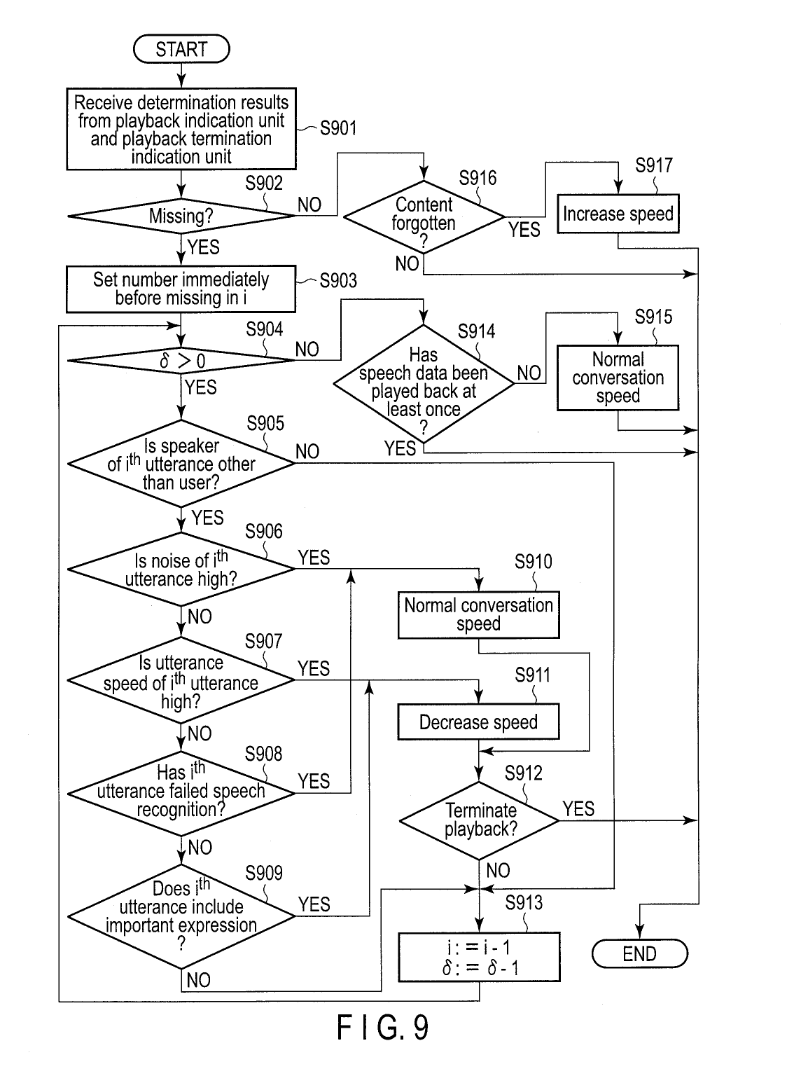

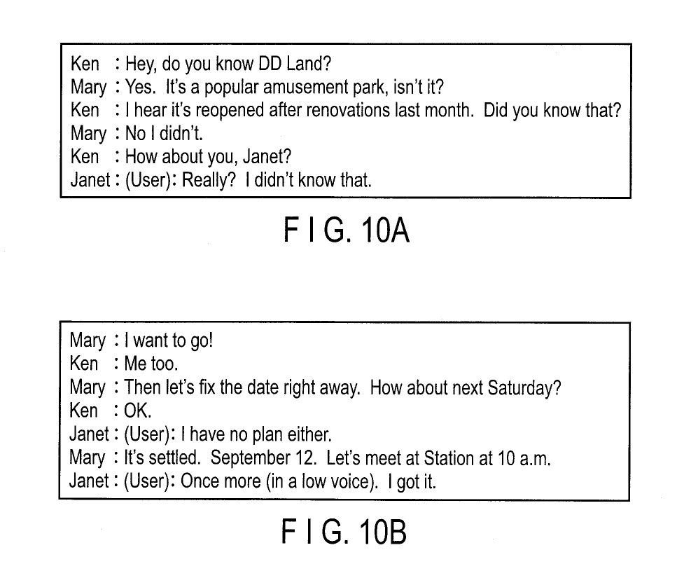

The playback speed setting unit 109 receives the playback data from the playback portion estimation unit 108, and sets the playback speed of the playback data. The operation of the playback speed setting unit 109 will be described later with reference to FIGS. 8 and 9.

The speech output unit 110 receives the playback data having the set playback speed from the playback speed setting unit 109, and outputs speeches by playing back the playback data at the set speed. Note that if no speed is set by the playback speed setting unit 109, the speeches of the playback data can be output at the conversation speed of ordinary conversation.

The speaker recognition unit 111 receives the divided speech data from the speech data analysis unit 103, and recognizes whether or not the speech of the divided speech data is the speech of the user of the speech conversation support apparatus 100, from the words and sound included in the divided speech data.

The utterance speed measurement unit 112 receives the divided speech data from the speech data analysis unit 103, and measures the utterance speed of the divided speech data from the words and sound included in the divided speech data. The utterance interval measurement unit 113 receives the divided speech data from the speech data analysis unit 103, and measures the utterance interval indicating the interval between utterances based on the sound included in the divided speech data.

The noise detection unit 114 receives the divided speech data from the speech data analysis unit 103, and detects an environmental sound (in this case, noise) other than speeches, from the sound included in the divided speech data. The speech recognition unit 115 receives the divided speech data from the speech data analysis unit 103, and converts the words included in the divided speech data into text data.

The important expression extracting unit 116 receives the text data from the speech recognition unit 115, and extracts important expressions from the text data. The important expressions are words that can function as keywords in conversation, for example, named entities such as the name of a place, the name of a person, and numerical expression, and technical terms.

The dividing process by the division unit 102 will be explained below with reference to a flowchart shown in FIG. 2.

In step S201, the division unit 102 performs speech recognition on speech data, and converts the speech data into text data. A general speech recognition process can be performed as this speech recognition, so an explanation thereof will be omitted.

In step S202, the division unit 102 performs morphological analysis on the speech data, and divides the text data based on the breaks between clauses. Since general morphological analysis can be used as this morphological analysis, an explanation thereof will be omitted. The dividing process is thus complete.

Next, another example of the dividing process by the division unit 102 will be explained below with reference to a flowchart shown in FIG. 3.

In step S301, the division unit 102 performs speaker recognition based on a sound included in speech data, and divides the data whenever a speaker changes. A general speaker recognition process can be performed as this speaker recognition process, so an explanation thereof will be omitted. Note that the speaker recognition unit 111 according to the first embodiment may also perform the recognition process on speech data acquired from the speech acquisition unit 101, and transmit the recognition result to the division unit 102.

In step S302, the division unit 102 detects silent periods, and divides the speech data by using the silent periods as breaks. For example, if the volume of the sound included in the speech data is not more than a predetermined value for a period not less than a threshold value, this period can be detected as a silent period. The process is thus complete. In this manner, the speech data can be divided at the breaks between speakers and utterances.

An example of the clue list to be referred to by the clue expression detection unit 105 will now be explained with reference to FIG. 4.

In a clue list 400, a clue expression 401, speaker/operator 402, utterance interval 403, volume 404, state 405, and result 406 are associated with each other. Note that “N/A” indicates the nonexistence of corresponding information in FIG. 4.

The speaker/operator 402 indicates whether a person having performed a clue expression (i.e., a person having uttered a clue word or a person having performed a clue action) is the user of the speech conversation support apparatus 100 according to the first embodiment. The clue utterance interval 403 indicates the length of an interval from an immediately preceding conversation to the utterance or action of a clue expression. The volume 404 indicates the volume of an uttered clue word. The state 405 indicates whether or not speech data stored (recorded) in the data storage 104 is being played back. The result 406 indicates the state of the user of the speech conversation support apparatus 100, or a post-process of the speech conversation support apparatus 100. Practical examples are “missing” indicating that the user has missed a speech, “content forgotten” indicating that the user has forgotten his or her own statement, “terminate playback” indicating that playback of speech data is to be terminated, and “continue playback” indicating that playback is to be continued.

In the clue list 400, for example, the clue expression 401 “Really”, the speaker/operator 402 “user”, the clue utterance interval 403 “N/A”, the volume 404 “high”, the state 405 “not being played back”, and the result 406 “missing” are associated with each other as a clue word. Also, the clue expression 401 “tap earphone once”, the speaker/operator 402 “user”, the clue utterance interval 403 “N/A”, the volume 404 “N/A”, the state 405 “being played back”, and the result 406 “terminate playback” are associated with each other as a clue action.

Assume that “Really” is uttered, a speaker having uttered the word is the user, the utterance volume is high, and no speech data is being played back. In this case, the clue expression detection unit 105 can detect the occurrence of “missing” indicating that the user has missed the statement of a conversation partner, by referring to the clue list 400.

Assume also that a word “well” is uttered, a speaker having uttered the word is the user, the utterance volume is high, and no speech data is being played back. In this case, if the clue utterance interval is short, the clue expression detection unit 105 detects the occurrence of “missing”. On the other hand, if the clue utterance interval is long, the clue expression detection unit 105 detects “content forgotten” indicating that the user has forgotten the content of his or her own statement.

As a practical process of detecting a clue expression, a clue word can be detected by receiving text data of divided speech data from the data storage 104, and determining whether or not there is a word matching the clue expression 401 in the clue list. Note that instead of this text matching, if a clue list includes frequency information of a speech or action as a clue expression, matching may also be performed using the frequency information of the speech. When detecting a clue action, for example, when detecting an action “tap earphone once” as the clue expression 401, a specific vibration pattern can be detected by a vibration detection unit (not shown). Similarly, when detecting an action “give OK sign by fingers” as the clue expression 401, it is possible to perform image analysis by an imaging unit (not shown) or the like, and determine whether or not the image matches a specific pattern.

Next, the operation of the playback indication unit 106 will be explained with reference to a flowchart shown in FIG. 5.

In step S501, the playback indication unit 106 receives the detection result from the clue expression detection unit 105.

In step S502, the playback indication unit 106 determines whether or not the detection result from the clue expression detection unit 105 is “missing”. If the detection result is “missing”, the process proceeds to step S503; if not, the process proceeds to step S504.

In step S503, the playback indication unit 106 generates a playback indication signal for indicating playback of speech data of a person other than the user, and terminates the process.

In step S504, the playback indication unit 106 determines whether or not the detection result from the clue expression detection unit 105 is “content forgotten”. If the detection result is “content forgotten”, the process proceeds to step S505; if not, the process is terminated.

In step S505, the playback indication unit 106 generates a playback indication signal for indicating playback of speech data of the user, and terminates the process.

The operation of the playback termination indication unit 107 will be explained below with reference to a flowchart shown in FIG. 6. Assume that a clue word is uttered as a clue expression in the following process.

In step S601, the playback termination indication unit 107 receives the detection result from the clue expression detection unit 105.

In step S602, the playback termination indication unit 107 determines whether or not the detection result from the clue expression detection unit 105 is “terminate playback”. If the detection result is “terminate playback”, the process proceeds to step S603; if not, the process is terminated.

In step S603, the playback termination indication unit 107 generates a playback termination indication signal for indicating termination of playback of speech data, and terminates the process.

The operation of the playback portion estimation unit 108 will be explained below with reference to a flowchart shown in FIG. 7A.

In step S701, the playback portion estimation unit 108 receives the determination results from the playback indication unit 106 and playback termination indication unit 107.

In step S702, the playback portion estimation unit 108 determines whether or not the determination result from the playback indication unit 106 is “missing”, i.e., determines whether or not a playback indication signal for playing back utterance (divided speech data) of a person other than the user is received from the playback indication unit 106. If the determination result is “missing”, the process proceeds to step S703; if not, the process proceeds to “A”. Process A will be described later with reference to FIG. 7B.

In step S703, the playback portion estimation unit 108 accesses the data storage 104, sets, in a variable i, the number of utterance immediately before the timing at which “missing” has occurred, i.e., immediately before the divided speech data matching a clue word for which the result 406 in FIG. 4 is “missing”, and reads out the i^{th} data. i is an integer of zero or more.

In step S704, the playback portion estimation unit 108 determines whether or not δ is greater than zero. δ is a preset parameter that controls until the time when the divided speech data is to be traced back, and has a value greater than or equal to zero. For example, if δ=10, then utterances are traced back to 10 words. If δ is greater than zero, the process proceeds to step S705. If δ is zero, the process proceeds to step S713.

In step S705, the playback portion estimation unit 108 determines whether or not a speaker having uttered the i^{th} speech in the speech data is other than the user. If the speaker is other than the user, the process proceeds to step S706. If the speaker is the user, the process proceeds to step S712.

In step S706, the playback portion estimation unit 108 determines whether or not the magnitude of noise included in the i^{th} utterance of the speech data is greater than a threshold value. If the magnitude of the noise is greater than the threshold value, the process proceeds to step S710. If the magnitude of the noise is less than or equal to the threshold value, the process proceeds to step S707.

In step S707, the playback portion estimation unit 108 determines whether or not the speed of the i^{th} utterance in the speech data is higher than a threshold value. If the speed of the utterance is higher than the threshold value, the process proceeds to step S710. If the speed of the utterance is lower than or equal to the threshold value, the process proceeds to step S708.

In step S708, the playback portion estimation unit 108 determines whether or not the i^{th} utterance in the speech data has failed speech recognition. If the i^{th} utterance has failed speech recognition, the process proceeds to step S710. If the i^{th} utterance has not failed speech recognition, i.e., if the i^{th} utterance has passed speech recognition, the process proceeds to step S709.

In step S709, the playback portion estimation unit 108 determines whether or not the i^{th} utterance in the speech data includes an important expression. If the i^{th} utterance includes an important expression, the process proceeds to step S710; if not, the process proceeds to step S712.

In step S710, the playback portion estimation unit 108 estimates that the i^{th} utterance in the speech data is playback data. In step S711, the playback portion estimation unit 108 determines whether or not the determination result from the playback termination indication unit 107 is “terminate playback”. If the determination result is “terminate playback”, the process is terminated; if not, the process proceeds to step S712.

In step S712, the playback portion estimation unit 108 decrements the variable i and parameter δ by 1 each, and repeats the same processing from step S704.

In step S713, the playback portion estimation unit 108 determines whether the speech data has been played back at least once. If the speech data has been played back at least once, the process is terminated; if not, the process proceeds to step S714.

In step S714, the playback portion estimation unit 108 estimates that utterance immediately before the timing at which “missing” has occurred is playback data, and terminates the process.

The operation of the playback portion estimation unit 108 when the determination result is not “missing” will now be explained with reference to a flowchart shown in FIG. 7B. FIG. 7B is the operation of the playback portion estimation unit 108, which follows process A shown in FIG. 7A.

In step S715, the playback portion estimation unit 108 determines whether or not the determination result from the playback indication unit 106 is “content forgotten”. If the determination result is “content forgotten”, the process proceeds to step S716; if not, the process is terminated.

In step S716, the playback portion estimation unit 108 accesses the data storage 104, sets, in the variable i, the number of utterance immediately before the timing at which “content forgotten” has occurred, i.e., immediately before the divided speech data matching a clue word for which the result 406 in FIG. 4 is “content forgotten”, and reads out the i^{th} data.

In step S717, the playback portion estimation unit 108 determines whether or not δ is greater than zero. If δ is greater than zero, the process proceeds to step S718. If δ is zero or less, the process proceeds to step S724.

In step S718, the playback portion estimation unit 108 determines whether or not a speaker having uttered the i^{th} speech in the speech data is other than the user. If the speaker is the user, the process proceeds to step S719. If the speaker is other than the user, the process proceeds to step S723.

In step S719, the playback portion estimation unit 108 determines whether or not the i^{th} utterance interval in the speech data is longer than a threshold value. If the utterance interval is longer than the threshold value, the process proceeds to step S721. If the utterance interval is shorter than or equal to the threshold value, the process proceeds to step S720.

In step S720, the playback portion estimation unit 108 determines whether or not the i^{th} utterance in the speech data includes an important expression. If the i^{th} utterance includes an important expression, the process proceeds to step S721; if not, the process proceeds to step S723.

In step S721, the playback portion estimation unit 108 estimates that the i^{th} utterance in the speech data is playback data. In step S722, the playback portion estimation unit 108 determines whether or not the determination result from the playback termination indication unit 107 is “terminate playback”. If the determination result is “terminate playback”, the process is terminated; if not, the process proceeds to step S723.

In step S723, the playback portion estimation unit 108 decrements the variable i and parameter δ by 1 each, and repeats the same processing from step S717.

In step S724, the playback portion estimation unit 108 determines whether the speech data has been played back at least once. If the speech data has been played back at least once, the process is terminated; if not, the process proceeds to step S725.

In step S725, the playback portion estimation unit 108 estimates that utterance immediately before the timing at which “content forgotten” has occurred is playback data, and terminates the process.

The operation of the playback speed setting unit 109 will be explained below with reference to a flowchart shown in FIG. 8.

In step S801, the playback speed setting unit 109 receives the determination result from the playback indication unit 106.

In step S802, the playback speed setting unit 109 determines whether or not the determination result is “missing”. If the determination result is “missing”, the process proceeds to step S803; if not, the process proceeds to step S804.

In step S803, the playback speed setting unit 109 decreases the playback speed of playback data because the user is probably unable to understand the content of conversation in case of “missing”. More specifically, the playback speed setting unit 109 calculates the average value of the utterance speeds of divided speech data, and sets the value of the playback speed of playback data to be less than the average value. Alternatively, the playback speed setting unit 109 presets the value of a general utterance speed, and sets the value of the playback speed of playback data to be less than the value of the general utterance speed.

In step S804, the playback speed setting unit 109 determines whether or not the determination result is “content forgotten”. If the determination result is “content forgotten”, the process proceeds to step S805; if not, the process is terminated.

In step S805, the playback speed setting unit 109 increases the playback speed of playback data because in case of “content forgotten” the user can recall the whole content if he or she recalls a given keyword pertaining to the content, and it is favorable to allow the user to recall the content as soon as possible. More specifically, the playback speed setting unit 109 sets the value of the playback speed to be greater than the average value of the utterance speeds. Thus, the operation of the playback speed setting unit 109 is complete.

Another example of the operation of the playback speed setting unit 109 will be explained below with reference to a flowchart shown in FIG. 9.

In step S901, the playback speed setting unit 109 receives the processing results from the playback indication unit 106 and playback termination indication unit 107.

In step S902, the playback speed setting unit 109 determines whether the processing results are “missing”. If the processing results are “missing”, the process proceeds to step S903; if not, the process proceeds to step S916.

In step S903, the playback speed setting unit 109 accesses the data storage 104, sets, in the variable i, the number of utterance immediately before the timing at which “missing” has occurred, and reads out the i^{th} data.

In step S904, the playback speed setting unit 109 determines whether or not δ is greater than zero. If δ is greater than zero, the process proceeds to step S905. If δ is zero, the process proceeds to step S914.

In step S905, the playback speed setting unit 109 determines whether or not a speaker having uttered the i^{th} speech in the speech data is other than the user. If the speaker is other than the user, the process proceeds to step S906. If the speaker is the user, the process proceeds to step S913.

In step S906, the playback speed setting unit 109 determines whether or not the magnitude of noise included in the i^{th} utterance of the speech data is greater than a threshold value. If the magnitude of the noise is greater than the threshold value, the process proceeds to step S910. If the magnitude of the noise is less than or equal to the threshold value, the process proceeds to step S907.

In step S907, the playback speed setting unit 109 determines whether or not the speed of the i^{th} utterance in the speech data is higher than a threshold value. If the speed of the utterance is higher than the threshold value, the process proceeds to step S911. If the speed of the utterance is equal to or lower than the threshold value, the process proceeds to step S908.

In step S908, the playback speed setting unit 109 determines whether or not the i^{th} utterance in the speech data has failed speech recognition. If the i^{th} utterance has failed speech recognition, the process proceeds to step S910. If the i^{th} utterance has not failed speech recognition, i.e., if the i^{th} utterance has passed speech recognition, the process proceeds to step S909.

In step S909, the playback speed setting unit 109 determines whether or not the i^{th} utterance in the speech data includes an important expression. If the i^{th} utterance includes an important expression, the process proceeds to step S911; if not, the process proceeds to step S913.

In step S910, the playback speed setting unit 109 sets the playback speed of the speech data at a normal conversation speed. The normal conversation speed can be obtained by, for example, calculating the average value of user's conversation speeds from the log of the conversation speeds.

In step S911, the playback speed setting unit 109 makes the playback speed of the speech data lower than that set in step S910.

In step S912, the playback speed setting unit 109 determines whether or not the processing result from the playback termination indication unit 107 is “terminate playback”. If the processing result is “terminate playback”, the process is terminated; if not, the process proceeds to step S913.

In step S913, the playback speed setting unit 109 decrements the variable i and parameter δ by 1 each, and repeats the same processing from step S904.

In step S914, the playback speed setting unit 109 determines whether or not the speech data has been played back at least once. If the speech data has been played back at least once, the process is terminated; if not, the process proceeds to step S915.

In step S915, the playback speed setting unit 109 sets the playback speed of the speech data at the normal conversation speed, and terminates the process.

In step S916, the playback speed setting unit 109 determines whether or not the processing result from the playback indication unit 106 is “content forgotten”. If the processing result is “content forgotten”, the process proceeds to step S917; if not, the process is terminated.

In step S917, the playback speed setting unit 109 sets the playback speed of the speech data to be higher than the normal conversation speed, in order to allow the user to recall the content as soon as possible in case of “content forgotten”. Thus, the operation of the playback speed setting unit 109 is complete. As described above, if the noise of playback data is large or the playback data has failed speech recognition, the playback speed setting unit 109 plays back the data at the normal conversation speed. If the speed of utterance of playback data is high or the playback data includes an important expression, the playback speed setting unit 109 decreases the playback speed to allow the user to readily understand the content.

The operation of the speech conversation support apparatus 100 according to the first embodiment will be explained below by using a practical example.

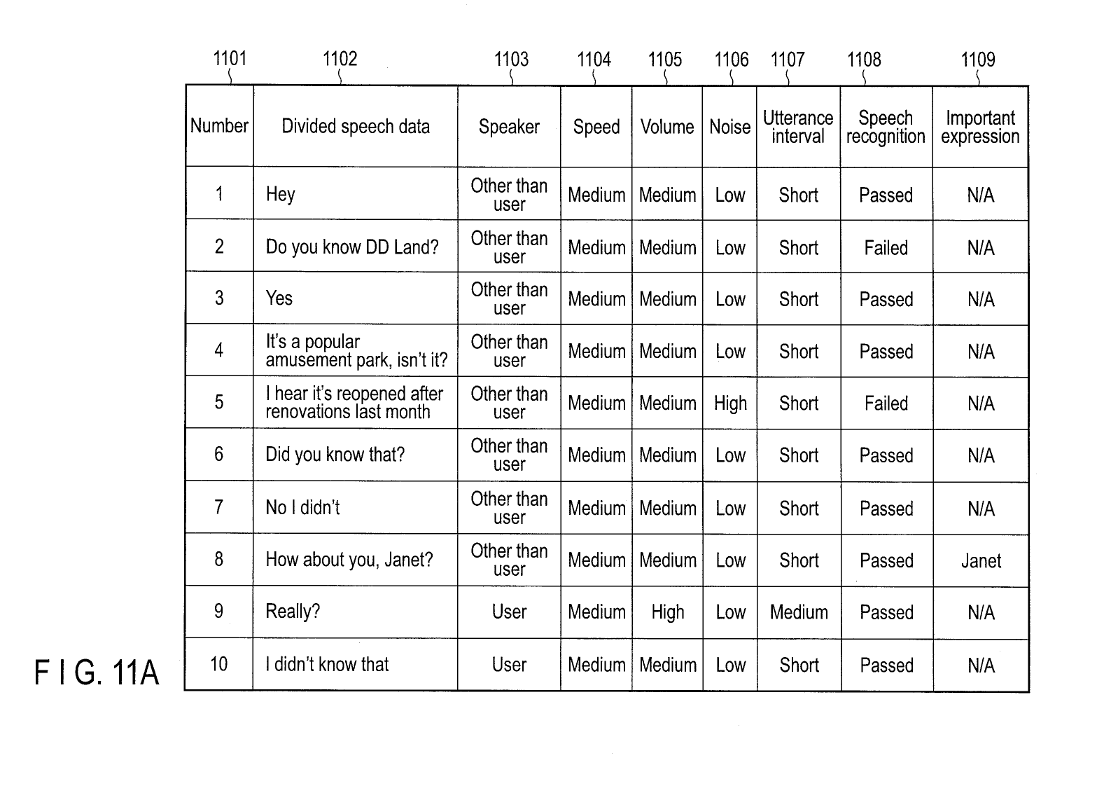

FIGS. 10A and 10B show examples of speech conversations to be input to the speech acquisition unit 101. That is, FIGS. 10A and 10B illustrate a series of conversations of Ken, Mary, and Janet. Janet is the user of the speech conversation support apparatus according to this embodiment.

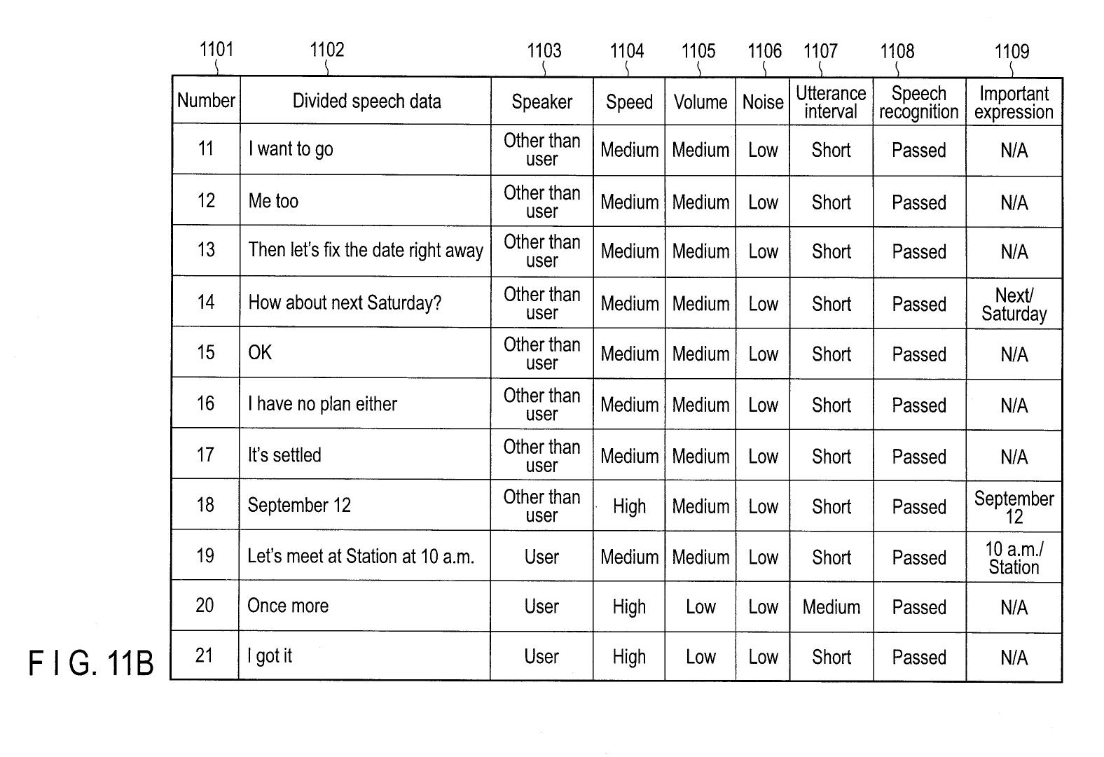

FIGS. 11A and 11B show examples of analytical data analyzed by the speech data analysis unit 103 and stored in the data storage 104.

FIG. 11A shows a table of analytical data obtained by analyzing the speech data shown in FIG. 10A. FIG. 11B shows a table of analytical data obtained by analyzing the speech data shown in FIG. 10B.

A number 1101, divided speech data 1102, speaker 1103, speed 1104, volume 1105, noise 1106, utterance interval 1107, speech recognition 1108, and important expression 1109 are stored in the data storage 104 as they are associated with each other. The number 1101 and divided speech data 1102 are the processing results from the division unit 102. The numbers 1101 are given in order of utterances in a speech conversation. The speech data is divided for every utterance break by using speaker changes and silent periods as breaks.

The speaker 1103 is the processing result from the speaker recognition unit 111. In this example, the speaker 1103 is described by two types, i.e., “user” and “other than user”. However, the speaker 1103 may also be described by specifying a speaker, such as “Ken”, “Mary”, or “Janet”.

The speed 1104 is the processing result from the utterance speed measurement unit 112. Although the speed 1104 is described by three types, i.e., “high”, “medium”, and “low” in this example, it may also be described by a speed value obtained by measurement.

The volume 1105 and noise 1106 are the processing results from the noise detection unit 114. The volume 1105 indicates the magnitude of the sound of utterance of the divided speech data. The noise 1106 indicates the magnitude of noise superposed on the sound utterance of the divided speech data. In this example, the volume 1105 and noise 1106 are described by three types, i.e., “high”, “medium”, and “low”. Similar to the speed 1104, however, the volume 1105 and noise 1106 may also be described by volume values.

The utterance interval 1107 is the processing result from the utterance interval measurement unit 113. Although the utterance interval 1107 is described by three types, i.e., “long”, “medium”, and “short” in this example, it may also be described by a measured time.

The speech recognition 1108 is the processing result from the speech recognition unit 115. In this example, the speech recognition 1108 is described by two types, i.e., “passed” and “failed”. However, the speech recognition 1108 may also be described by finer classifications, or by likelihood information output during the speech recognition process.

The important expression 1109 is the processing result from the important expression extraction unit 116. The important expression 1109 is described as “N/A” if there is no word regarded as an important expression.

For example, the number 1101 “1”, the divided speech data 1102 “hey”, the speaker 1103 “other than user”, the speed 1104 “medium”, the volume 1105 “medium”, the noise 1106 “low”, the utterance interval 1107 “short”, the speech recognition 1108 “passed”, and the important expression 1109 “N/A” are associated with each other.

A practical operation of the speech conversation support apparatus 100 will be explained below with reference to FIGS. 11A and 11B.

When the divided speech data 1102 “Really” of the number 1101 “9” shown in FIG. 11A is uttered, the clue expression detection unit 105 refers to the clue list, and detects that the divided speech data “Really” is a clue word suggesting “missing”. The playback indication unit 106 receives the detection result “missing”, and generates a playback indication signal for divided speech data of a person other than the user. After that, the playback portion estimation unit 108 estimates divided speech data (playback data) to be played back by performing the operation indicated by the flowchart shown in FIG. 7A. In the example shown in FIG. 11A, the playback portion estimation unit 108 traces back the numbers 1101 in order from the divided speech data 1102 “Really” of the number 1101 “9”, and estimates that the divided speech data 1102 “how about you, Janet?” of the number 1101 “8” is playback data because the divided speech data 1102 “how about you, Janet?” includes an important expression.

Furthermore, the playback speed setting unit 109 sets a low playback speed by performing the operation indicated by the flowchart shown in FIG. 9 because “how about you, Janet” includes an important expression, and the speech output unit 110 plays back the playback data. Note that the speech data is kept played back because the user does not utter a word indicating playback termination (“OK” or “I got it” in FIG. 4).

Subsequently, the playback portion estimation unit 108 estimates that the divided speech data 1102 “I hear it's reopened after renovations last month” of the number 1101 “5” is playback data, because the noise 1106 is higher than the threshold value. The playback speed setting unit 109 sets the playback speed of the speech data “I hear it's reopened after renovations last month” at the normal conversation speed because the noise 1106 is higher than the threshold value, and the speech output unit 110 plays back the playback data. The playback data is kept played back because the user does not utter a word indicating playback termination.

The playback portion estimation unit 108 estimates that the divided speech data 1102 “Do you know DD Land?” of the number 1101 “2” is playback data, because the speech recognition 1108 is “failed”. The playback speed setting unit 109 sets the playback speed of the speech data “Do you know DD Land?” at the normal conversation speed, and the speech output unit 110 plays back the playback data. The playback is terminated because there is no more divided speech data that can be playback data.

The above-described processing shows that it is highly likely that Janet as the user has missed either the phrase “Do you know DD Land?” having failed speech recognition because the phrase includes a generally unknown proper noun, or the phrase “I hear it's reopened after renovations last month” that was difficult to hear because the noise was high. Accordingly, it is possible to efficiently support the conversation by playing back these speech data.

As another example, the operation performed by the speech conversation support apparatus for the speech data shown in FIG. 11B which is the continuation of the speech data shown in FIG. 11A will be explained below.

When the divide speech data 1102 “once more” of the number 1101 “20” is uttered, the clue expression detection unit 105 refers to the clue list, and detects that the phrase “once more” is a clue word suggesting “missing”. The playback indication unit 106 receives the detection result “missing”, and generates a playback indication signal for divided speech data of a person other than the user. After that, the playback portion estimation unit 108 estimates that the divided speech data 1102 “Let's meet at Station at 10 a.m.” of the number 1101 “19” is playback data, because “Let's meet at Station at 10 a.m.” includes important expressions (“10 a.m.” and “Station”). Furthermore, the playback speed setting unit 109 decreases the playback speed of the divided speech data 1102 “Let's meet at Station at 10 a.m.” including important expressions, and plays back the playback data.

When the divided speech data 1102 “I got it” of the number 1101 “21” is uttered, the clue expression detection unit 105 detects that this divided speech data is a clue word indicating “terminate playback”, and the playback termination indication unit 107 generates a playback termination indication signal, thereby terminating the playback of the playback data.

It is highly likely that Janet uttered the word “once more” because she wanted to reconfirm the meeting time and meeting place. Therefore, it is possible to efficiently support the conversation by playing back the playback data including important expressions.

In the first embodiment described above, conversations can efficiently be supported by playing back speech data based on clue expressions, and estimating that speech data to be played back is playback data based on the analysis results of the speech data. In addition, the playback speed of the playback data can be changed based on the analysis results of the speech data. This makes it possible to change the playback speed of the speech data in accordance with how the user wants to hear the data again, and efficiently play back the speech data.

### Second Embodiment

In the first embodiment, the whole of one divided speech data obtained by the division unit 102 is played back. The second embodiment differs from the first embodiment in that a part of one divided speech data is extracted and played back.

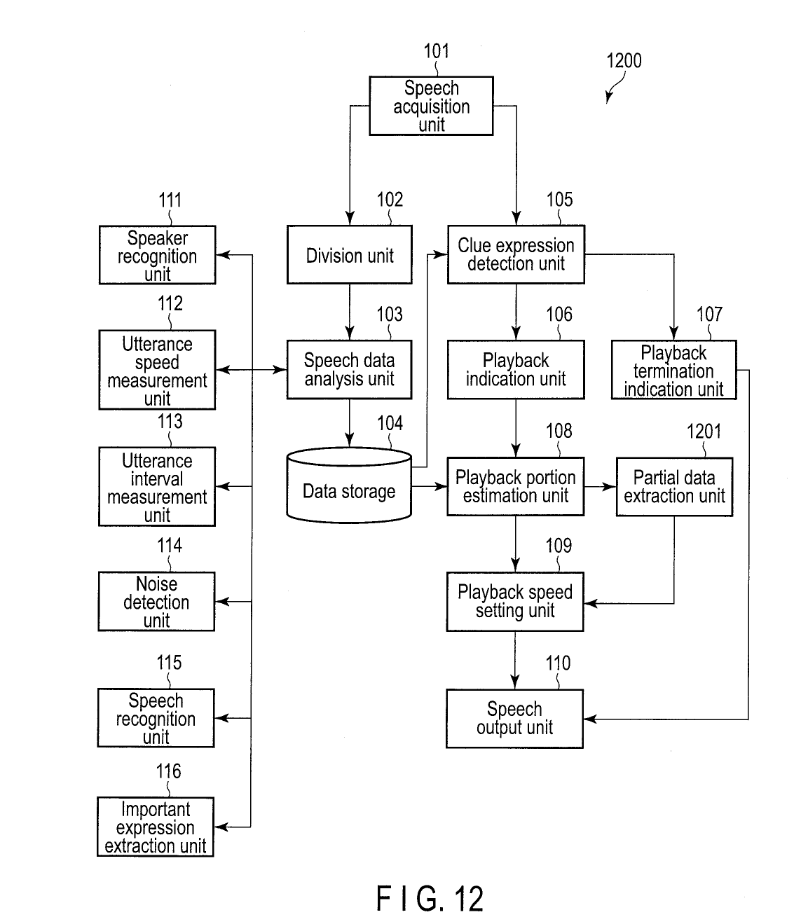

A speech conversation support apparatus according to the second embodiment will be explained below with reference to FIG. 12.

A speech conversation support apparatus 1200 according to the second embodiment includes a speech acquisition unit 101, division unit 102, speech data analysis unit 103, data storage 104, clue expression detection unit 105, playback indication unit 106, playback termination indication unit 107, playback portion estimation unit 108, playback speed setting unit 109, speech output unit 110, speaker recognition unit 111, utterance speed measurement unit 112, utterance interval measurement unit 113, noise detection unit 114, speech recognition unit 115, important expression extraction unit 116, and partial data extraction unit 1201.

The components other than the partial data extraction unit 1201 perform the same operations as in the first embodiment, so an explanation thereof will be omitted.

The partial data extraction unit 1201 receives playback data from the playback portion estimation unit 108, and extracts partial data from the playback data.

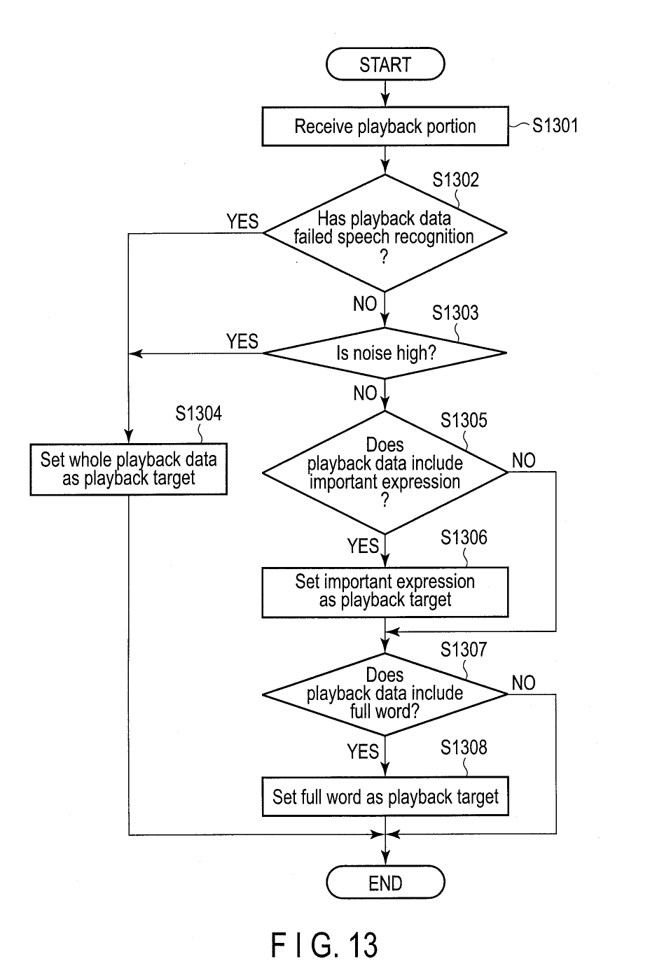

The operation of the partial data extraction unit 1201 will be explained below with reference to a flowchart shown in FIG. 13.

In step S1301, the partial data extraction unit 1201 receives playback data from the playback portion estimation unit 108.

In step S1302, the partial data extraction unit 1201 determines whether or not playback data has failed speech recognition. If the playback data has failed speech recognition, the process proceeds to step S1303. If the playback data has not failed speech recognition, i.e., if the playback data has passed speech recognition, the process proceeds to step S1304.

In step S1303, the partial data extraction unit 1201 determines whether or not the noise of the playback data is higher than a threshold value. If the noise is higher than the threshold value, the process proceeds to step S1304; if not, the process proceeds to step S1305.

In step S1304, the partial data extraction unit 1201 sets speech data of the whole playback portion as a playback target, and terminates the process.

In step S1305, the partial data extraction unit 1201 determines whether or not the playback data includes an important expression. If the playback data includes an important expression, the process proceeds to step S1306; if not, the process proceeds to step S1307.

In step S1306, the partial data extraction unit 1201 extracts an important expression part of the playback data as the playback target.

In step S1307, the partial data extraction unit 1201 determines whether or not the playback data includes a full word. A full word is a word with lexical meaning. Examples of a full word are a noun, verb, adjective, and adverb. If the playback data includes a full word, the process proceeds to step S1308; if not, the process is terminated.

In step S1308, the partial data extraction unit 1201 extracts a full word of the playback data as the playback target, and terminates the process.

Thus, the processing of the partial data extraction unit 1201 is complete.

More specifically, when playing back the utterance data “Let's meet at Station at 10 a.m.” of the number “19” shown in FIG. 11B as playback data, for example, three playback data “10 a.m.”, “Station”, and “meet” are extracted by the steps shown in FIG. 13 described above. This makes it possible to efficiently play back only important portions.

The second embodiment described above can provide efficient information for the user without disturbing a flow of conversation, by extracting only necessary portions of a playback portion and playing back speech data.

The arrangement of the speech conversation support apparatus according to the embodiment can also be divided into a terminal and server. For example, the terminal can include the speech acquisition unit 101 and speech output unit 110. The server can include the division unit 102, speech data analysis unit 103, data storage 104, clue expression detection unit 105, playback indication unit 106, playback termination indication unit 107, playback portion estimation unit 108, playback speed setting unit 109, speaker recognition unit 111, utterance speed measurement unit 112, utterance interval measurement unit 113, noise detection unit 114, speech recognition unit 115, and important expression extraction unit 116. The speech conversation support apparatus 1200 according to the second embodiment can include the partial data extraction unit 1201 in addition to the above-described server configuration.

In this arrangement, the amount of processing on the terminal can be reduced because the server can perform arithmetic processing requiring a large calculation amount. Consequently, the arrangement of the terminal can be simplified.

Note that the instructions indicated by the procedures disclosed in the above-described embodiments can be executed based on a program as software.

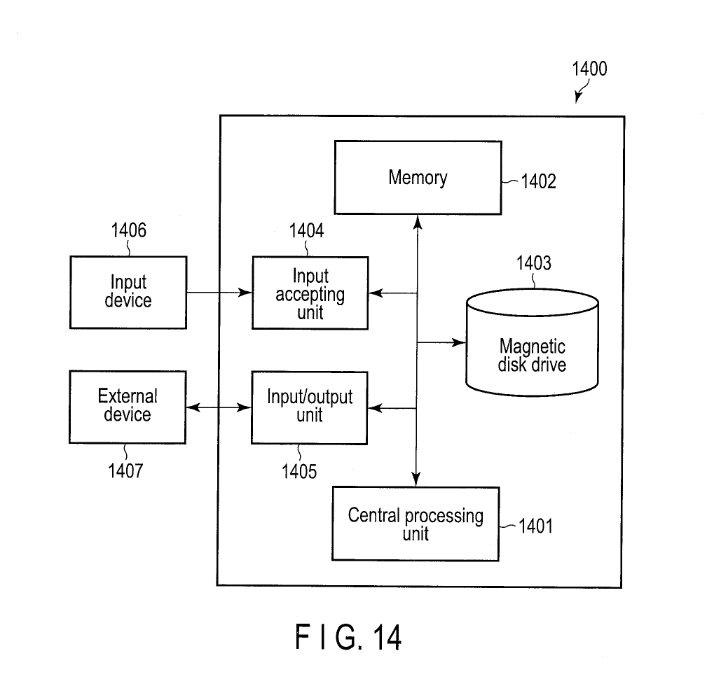

An example of a computer when implementing the speech conversation support apparatuses according to the first and second embodiments as programs will be explained below with reference to FIG. 14.

A computer 1400 includes a central processing unit (to be also referred to as a CPU hereinafter) 1401, memory 1402, magnetic disk drive 1403, input accepting unit 1404, input/output unit 1405, input device 1406, and external device 1407.

The magnetic disk drive 1403 stores programs and attached data for causing the computer to function as each unit of the speech conversation support apparatus.

The memory 1402 temporarily stores a program currently being executed and data to be processed by the program.

The CPU 1401 reads out and executes a program stored in the memory 1402.

The input accepting unit 1404 accepts inputting of a sound signal from the input device 1406 (to be described below).

The input/output unit 1405 outputs speech data as a playback target to the external device 1407 (to be described below).

The input device 1406 is a microphone or the like, and collects speeches and surrounding noise.

The external device 1407 is an earphone or the like, and outputs speech data received from the input device 1406 outside.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech conversation support apparatus, comprising:
a division unit configured to divide, a speech data item including a word item and a sound item, into a plurality of divided speech data items, in accordance with at least one of a first characteristic of the word item and a second characteristic of the sound item;
an analysis unit configured to obtain an analysis result on the at least one of the first characteristic and the second characteristic, for each divided speech data item;
a first detection unit configured to detect, for each divided speech data item, at least one clue expression indicating one of an instruction by a user and a state of the user in accordance with at least one of an utterance by the user and an action by the user;
an estimation unit configured to estimate, if the clue expression is detected, at least one playback data item from at least one divided speech data item corresponding to a speech uttered before the clue expression is detected, based on the analysis result; and
an output unit configured to output the playback data item.

2. The apparatus according to claim 1, further comprising an indication unit configured to generate, if the clue expression detected by the first detection unit indicates termination of playback of the playback data item, a termination indication signal indicating termination of playback of the playback data item.

3. The apparatus according to claim 1, further comprising a first recognition unit configured to determine whether or not the speech data item is uttered by the user,
wherein if the clue expression indicates that the user has missed a speech by a person other than the user, the estimation unit estimates the playback data item, from first speech data indicating an utterance of a person other than the user.

4. The apparatus according to claim 1, further comprising:
a second recognition unit configured to convert the speech data item into text data item;
a first extraction unit configured to extract, from the text data item, an important expression which is words having a possibility of a keyword in a conversation;
a second detection unit configured to detect noise other than a speech included in the speech data item; and
a first measurement unit configured to measure an utterance speed of the speech data item,
wherein the analysis unit obtains the analysis result based on results processed by the second recognition unit, the first extraction unit, the second detection unit, and the first measurement unit, and
if the clue expression indicates that the user has missed a speech by a person other than the user, the estimation unit obtains, as playback data items, from a first speech data item indicating an utterance of a person other than the user, at least one of a second speech data item and a third speech data item, the second speech data item being a divided speech data item satisfying at least one of conditions that the data has failed speech recognition, the first speech data item includes the important expression, the noise is not less than a first threshold value, and the utterance speed is not less than a second threshold value, the third speech data item being a divided speech data item uttered immediately before the clue expression.

5. The apparatus according to claim 4, further comprising a second extraction unit configured to extract, if the playback data item includes at least one of the important expression and a full word, corresponding words of the important expression and the full word from the playback data item as a partial data item,
wherein if the partial data item is extracted, the output unit outputs only the partial data item.

6. The apparatus according to claim 1, further comprising a first recognition unit configured to determine whether or not the speech data item is uttered by the user,
wherein if the clue expression indicates that the user has forgotten content of the user's own statement, the estimation unit estimates the playback data item from fourth speech data item indicating an utterance by the user.

7. The apparatus according to claim 1, further comprising:
a second recognition unit configured to convert the speech data item into text data item;
a first extraction unit configured to extract, from the text data item, an important expression which is words having a possibility of a keyword in a conversation; and
a second measurement unit configured to measure an interval between utterances in the speech data item,
wherein the analysis unit obtains the analysis result based on results processed by the second recognition unit, the first extraction unit, and the second measurement unit, and
if the clue expression indicates that the user has forgotten content of the user's own statement, the estimation unit obtains, as playback data items, from fourth speech data item indicating an utterance by the user, at least one of a fifth speech data item and a six speech data item, the fifth speech data item satisfying at least one of conditions that the data includes the important expression and the interval is not less than a third threshold value, and the sixth speech data item uttered immediately before the clue expression.

8. The apparatus according to claim 7, further comprising a second extraction unit configured to extract, if the playback data item includes at least one of the important expression and a full word, corresponding words of the important expression and the full word from the playback data item as a partial data item,
wherein if the partial data item is extracted, the output unit outputs only the partial data item.

9. The apparatus according to claim 1, further comprising a setting unit configured to set a playback speed of the playback data item based on the analysis result.

10. A speech conversation support method, comprising:
Dividing, a speech data item including a word item and a sound item, into a plurality of divided speech data items, in accordance with at least one of a first characteristic of the word item and a second characteristic of the sound item;
obtaining an analysis result on the at least one of the first characteristic and the second characteristic, for each divided speech data item;
detecting, for each divided speech data item, at least one clue expression indicating one of an instruction by a user and a state of the user in accordance with at least one of an utterance by the user and an action by the user;
estimating, if the clue expression is detected, at least one playback data item from at least one divided speech data item corresponding to a speech uttered before the clue expression is detected, based on the analysis result; and
outputting the playback data item.

11. The method according to claim 10, further comprising generating, if the clue expression detected by the first detection unit indicates termination of playback of the playback data item, a termination indication signal indicating termination of playback of the playback data item.

12. The method according to claim 10, further comprising determining whether or not the speech data item is uttered by the user,
wherein if the clue expression indicates that the user has missed a speech by a person other than the user, the estimating the at least one playback data item estimates the playback data item, from first speech data indicating an utterance of a person other than the user.

13. The method according to claim 10, further comprising:
converting the speech data item into text data item;
extracting, from the text data item, an important expression which is words having a possibility of a keyword in a conversation;
detecting noise other than a speech included in the speech data item; and
measuring an utterance speed of the speech data item,
wherein the obtaining the analysis result obtains the analysis result based on results processed by the converting the speech data item, the extracting the important expression, the detecting the noise, and the measuring the utterance speed, and
if the clue expression indicates that the user has missed a speech by a person other than the user, the estimating the at least one playback data item obtains, as playback data items, from a first speech data item indicating an utterance of a person other than the user, at least one of a second speech data item and a third speech data item, the second speech data item being a divided speech data item satisfying at least one of conditions that the data has failed speech recognition, the first speech data item includes the important expression, the noise is not less than a first threshold value, and the utterance speed is not less than a second threshold value, the third speech data item being a divided speech data item uttered immediately before the clue expression.

14. The method according to claim 13, further comprising extracting, if the playback data item includes at least one of the important expression and a full word, corresponding words of the important expression and the full word from the playback data item as a partial data item,
wherein if the partial data item is extracted, the outputting the playback data item outputs only the partial data item.

15. The method according to claim 10, further comprising determining whether or not the speech data item is uttered by the user,
wherein if the clue expression indicates that the user has forgotten content of the user's own statement, the estimating the at least one playback data item estimates the playback data item from fourth speech data item indicating an utterance by the user.

16. The method according to claim 10, further comprising:
converting the speech data item into text data item;
extracting, from the text data item, an important expression which is words having a possibility of a keyword in a conversation; and
measuring an interval between utterances in the speech data item,
wherein the analysis unit obtains the analysis result based on results processed by the converting the speech data item, the extracting the important expression, and the measuring the interval, and
if the clue expression indicates that the user has forgotten content of the user's own statement, the estimating the at least one playback data item obtains, as playback data items, from fourth speech data item indicating an utterance by the user, at least one of a fifth speech data item and a six speech data item, the fifth speech data item satisfying at least one of conditions that the data includes the important expression and the interval is not less than a third threshold value, and the sixth speech data item uttered immediately before the clue expression.

17. The method according to claim 16, further comprising extracting, if the playback data item includes at least one of the important expression and a full word, corresponding words of the important expression and the full word from the playback data item as a partial data item,
wherein if the partial data item is extracted, the outputting the playback data item outputs only the partial data item.

18. The method according to claim 10, further comprising setting a playback speed of the playback data item based on the analysis result.

19. A non-transitory computer readable medium including computer executable instructions, wherein the instructions, when executed by a processor, cause the processor to perform a method comprising:
dividing a speech data item including a word item and a sound item into a plurality of divided speech data items, in accordance with at least one of a first characteristic of the word item and a second characteristic of the sound item;
obtaining an analysis result on the at least one of the first characteristic and the second characteristic, for each divided speech data item;
detecting, for each divided speech data item, at least one clue expression indicating one of an instruction by a user and a state of the user in accordance with at least one of an utterance by the user and an action by the user;
estimating, if the clue expression is detected, at least one playback data item from at least one divided speech data item corresponding to a speech uttered before the clue expression is detected, based on the analysis result; and
outputting the playback data item.

20. The medium according to claim 19, further comprising generating, if the clue expression detected by the first detection unit indicates termination of playback of the playback data item, a termination indication signal indicating termination of playback of the playback data item.
